(19) United States
(12) Patent Application Publication
(10) Pub. No.: US 2012/0102291 A1
(43) Pub. Date: Apr. 26, 2012

(54) System and Method for Storage Allocation in a Cloud Environment

(75) Inventors: Jacob Cherian, Austin, TX (US); Gaurav Chawla, Austin, TX (US)

(73) Assignee: DELL PRODUCTS, LP, Round Rock, TX (US)

(21) Appl. No.: 12/912,197

(22) Filed: Oct. 26, 2010

(51) Int. Cl. G06F 12/02; G06F 12/00

(52) U.S. Cl. 711/170; 711/E12.001; 711/E12.002

(57) ABSTRACT

A system includes a host processing system that launches virtual machines, a switched fabric, a storage area network that provides storage capabilities to the virtual machines, and a virtualized cloud environment manager that receives workload service profiles. The manager includes a virtual machine allocation framework that directs the host to launch a virtual machine in response to receiving a service profile, a network allocation framework that directs the fabric to provide network connectivity to the virtual machine in response to receiving the service profile, and a storage allocation framework with a workload interface that receives a workload storage requirement from the service profile, a storage capabilities database that determines capabilities of the network, and a storage manager that determines a storage allocation from the capabilities and allocates storage to the workload.

### FIELD OF THE DISCLOSURE

This disclosure generally relates to information handling systems, and more particularly relates to storage allocation in a cloud environment.

### BACKGROUND

As the value and use of information continues to increase, individuals and businesses seek additional ways to process and store information. One option is an information handling system. An information handling system generally processes, compiles, stores, or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are illustrated and described with respect to the drawings presented herein, in which:

FIG. 1 is a functional block diagram of a virtualized cloud environment according to an embodiment of the present disclosure;

FIG. 2 is a functional block diagram of a virtualized cloud environment manager according to an embodiment of the present disclosure;

FIG. 3 is an illustration of a service profile for use by a virtualized cloud environment manager;

FIG. 4 is a flow chart illustrating an embodiment of a method for storage allocation in a cloud environment; and

FIG. 5 is a functional block diagram illustrating an exemplary embodiment of an information handling system.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can be used in this application. The teachings can also be used in other applications, and with several different types of architectures, such as distributed computing architectures, client/server architectures, or middleware server architectures and associated resources.

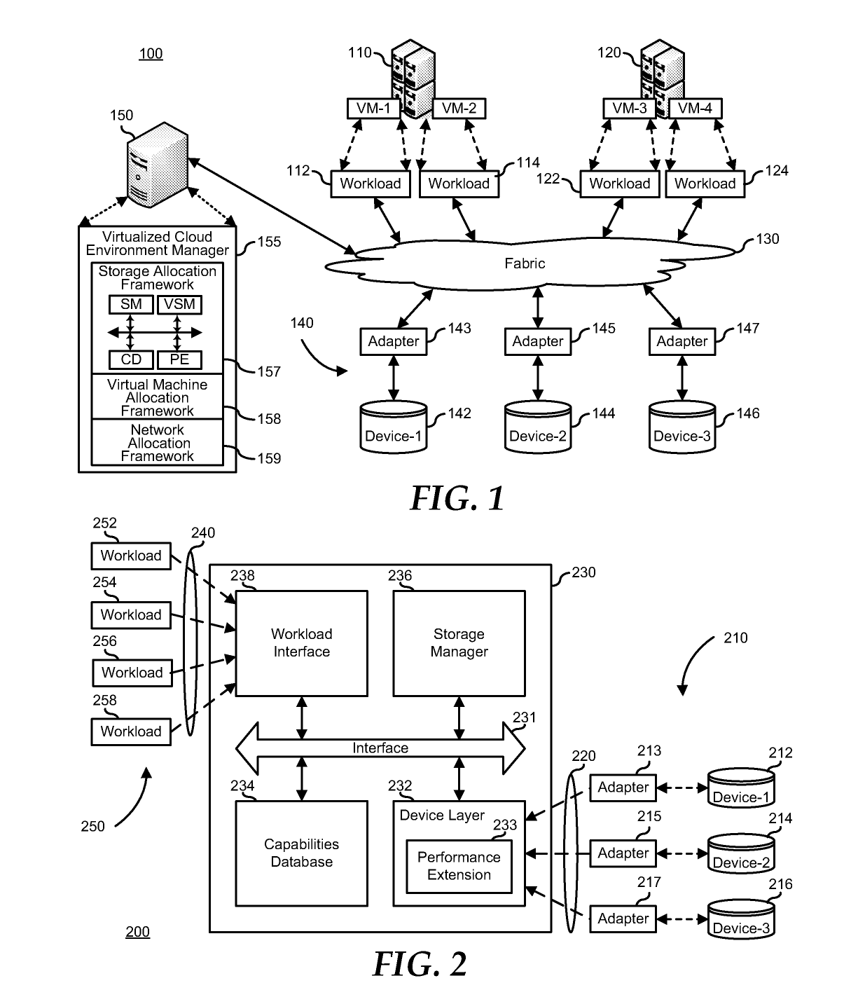

FIG. 1 illustrates a virtualized cloud environment 100 according to an embodiment of the present disclosure. Virtualized cloud environment 100 is an embodiment of an information handling system that includes a host processing system 110, one or more additional host processing systems 120, a switched fabric 130, a storage area network (SAN) 140, and a management server 150. The processing resources of host processing systems 110 and 120 are allocated to one or more virtual machines operating on their respective host processing system to perform associated workloads. As such, host processing system 110 includes a workload 112 associated with a first virtual machine (VM-1) and one or more additional workloads 114 associated with one or more additional virtual machines (VM-2). Similarly, host processing system 120 includes a workload 122 associated with a third virtual machine (VM-3) and one or more additional workloads 124 associated with one or more additional virtual machines (VM-4). Workloads 112, 114, 122, and 124 share the resources of host bus adapters (not illustrated) within their respective host processing systems 110 and 120 to gain access to the network switching functionality of fabric 130 and to the data storage functionality of SAN 140. The host bus adapters transfer data between their respective host processing systems 110 and 120 and fabric 130 according to a particular protocol associated with the fabric. A non-limiting example of a fabric 130 includes a Small Computer System Interface (SCSI) fabric, a Fibre Channel (FC) fabric, an Internet SCSI (iSCSI) fabric, another data fabric or any combination thereof.

SAN 140 includes one or more storage devices represented by storage devices 142, 144, and 146. Each storage device 142, 144, and 146 operates to store and retrieve data for workloads 112, 114, 122, and 124, and includes an associated device adapter 143, 145, and 147, respectively. Device adapters 143, 145, and 147 operate to receive data in a format suitable for communication via fabric 130, and to provide the received data in a suitable format for the respective storage device 142, 144, and 146. Storage devices 142, 144, and 146 can represent physical storage devices such as disk storage arrays, tape backup storage devices, solid state storage devices, other physical storage devices, or a combination thereof. Also, storage devices 142, 144, and 146 can represent virtual storage devices such as virtual partitions on one or more physical storage device. Moreover, storage devices 142, 144, and 146 can represent a combination of physical and virtual storage devices. As such, device adapters 143, 145, and 147 can represent physical device adapters, virtual device adapters, or a combination thereof.

Management server 150 is connected to fabric 130, and includes a virtualized cloud environment manager 155. Virtualized cloud environment manager 155 includes a storage allocation framework 157, a virtual machine allocation framework 158, and a network allocation framework 159. In operation, management server 150 functions to receive requests for the processing resources of host processing systems 110 and 120, for the network switching resources of fabric 130, and for the data storage resources of SAN 140, and to allocate the various resources among the received requests. For example, a request for a particular workload can be received by management server 150, and virtualized cloud environment manager 155 can determine that one or more of host processing systems 110 and 120 have available processing resources to implement the requested workload. Virtual machine allocation framework 158 can then launch the requested workload by providing the processing requirements of the workload to a virtual machine manager in the selected host processing system 110 or 120. The workload request can also include requirements for network connectivity capabilities in fabric 130, and network allocation framework 159 can allocate the switching resources of the fabric accordingly. Further, the workload request can include requirements for storage resources within SAN 140, and storage allocation framework 157 can determine the storage capabilities of the SAN and allocate the storage resources accordingly. In the illustrated embodiment, management server 150 is implemented as a separate processing resource in virtualized cloud environment 100. In other embodiments (not illustrated), the functionality of management server 150 is performed by host processing system 110, by host processing system 120, is distributed between the host processing systems, or is performed by another processing resource of virtualized cloud environment 100.

FIG. 2 illustrates an embodiment of a virtualized cloud environment 200 similar to virtualized cloud environment 100, including a SAN 210, a storage allocation framework 230, and virtualized hosts 250. Storage allocation framework 230 includes a device layer 232, a capabilities database 234, a storage manager 236, and a workload interface 238. Device layer 232, capabilities database 234, storage manager 236, and workload interface 238 are connected to a common interface 231 to pass communication between each other. In a particular embodiment, storage allocation framework 230 is implemented within a particular processing resource within an information handling system, such as within management server 150, and interface 231 includes a hardware interface between the elements of the storage allocation framework. In another embodiment, the elements of storage allocation framework 230 are distributed among one or more processing resources within an information handling system. Here, interface 231 can be a common communication layer between the elements of storage allocation framework, such that communications between the elements share a common communication protocol such as transmission control protocol/Internet protocol (TCP/IP) packets on an information handing system such as virtualized cloud environment 100. Storage allocation framework 230 operates to receive storage resource information 220 from a SAN 210. Storage allocation framework 230 also operates to receive workload storage requirements 240 from hosts 250.

SAN 210 includes storage devices 212, 214, and 216, similar to storage devices 142, 144, and 146, respectively. Each storage device 212, 214, and 216 includes an associated device adapter 213, 215, and 217, similar to device adapters 143, 145, and 147, respectively. Device layer 232 interfaces with the elements of SAN 210 to receive storage resource information 220. Storage resource information 220 includes static information and performance information. The static information includes physical or virtual capabilities for storage devices 212, 214, and 216. For example, the storage device capabilities can include storage capacity, partitions and partition sizes, file systems associated with the partitions, data access speeds, maximum data throughput rates, other storage device capabilities, or a combination thereof. The static information also includes physical or virtual capabilities for device adapters 213, 215, and 217. The device adapter capabilities can include interface standards such as SCSI, iSCSI, Serial Advanced Technology Attachment (SATA), or another interface standard, redundancy information such as Redundant Array of Independent Drives (RAID) levels, maximum data throughput rates, other device adapter capabilities, or a combination thereof. Device layer 232 includes a performance extension 233 that operates to determine the performance information of SAN 210. For example, performance extension 233 can determine headroom in storage devices 212, 214, and 216, based upon the storage capacity information and the current utilization. Performance extension 233 also monitors changes in the configuration of SAN 210. For example, performance extension 233 can determine when a storage device or device adapter is added to or removed from SAN 210. Where SAN 210 supports Quality of Service (QoS) or input/output (I/O) capping, device layer 232 operates to provide enforcement functions.

Capabilities database 234 operates to receive the static information and the performance information from device layer 232 for storage devices 212, 214, and 216, for device drivers 213, 215, and 217, and for any other storage devices discovered or managed by storage allocation framework 230. Capabilities database 234 further operates to perform statistical analysis on the static information and the performance information to model SAN 210 under a wide variety of load conditions and configurations. Thus the capabilities of SAN 210 as reported by capabilities database 234 are dynamically updated to provide real time analysis of the storage capacity and other capabilities of the SAN.

Workload interface 238 operates to receive workload storage requirements 240 from workload 252, 254, 256, and 258, similar to workloads 112, 114, 122, and 124. In a particular embodiment, workload interface 238 includes a user interface (not illustrated) that permits a manager of a virtualized cloud environment such as virtualized cloud environment 100 to add, delete, or migrate workloads into virtualized cloud environment 200. In another embodiment, virtualized cloud environment 200 operates to automatically create a new workload in hosts 250, to allocate network switching resources for the new workload, and to generate workload storage requirements 240 for the new workload.

Storage manager 236 operates to receive the requirements for each workload 252, 254, 256, and 258, compare the requirements with the available capabilities as reported by capabilities database 234, and to match the workloads to one or more resource of SAN 210. As such, storage manager 236 includes business logic that operates to optimize the resources of SAN 210 based upon the existing workload storage requirements 240, and to manage changes in hosts 250, such as the addition, deletion, or migration of workloads 252, 254, 256, and 258. Storage manager 236 also operates to create a virtual device adapter and an associated virtual storage device, as needed or desired. Storage manager 236 also operates to provide a library of pre-characterized storage applications such that a workload storage requirement 240 can be provided in terms of a particular application or with a pre-characterized allocation template. For example, a workload storage requirement can specify that an electronic mail workload is expected to have 300 heavy electronic mail users each with 400 gigabyte (GB) mailboxes and an expected average latency of not more than 20 milliseconds (ms), and storage manager 236 can allocate storage resources of SAN 210 according to pre-determined allocation guidelines.

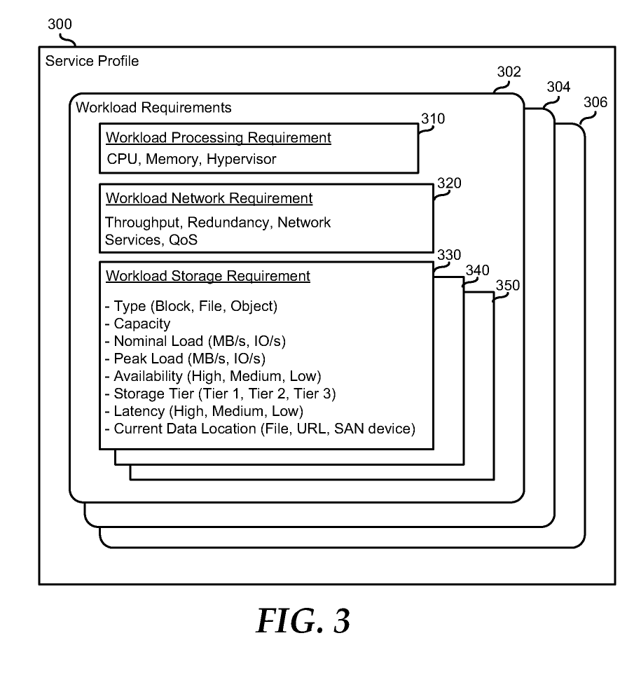

FIG. 3 illustrates an embodiment of a service profile 300 for use by a virtualization cloud environment manager similar to virtualized cloud environment manager 155 or in virtualized cloud environment 200. Service profile 300 includes workload requirements 302, 304, and 306. Service profile 300 is provided to the virtualization manager when a new workload is being added to the information handling system, or when an existing workload in a different information handling system is being migrated to the information handling system. Workload requirement 302 is illustrative of workloads 304 and 306, and includes a workload processing requirement descriptor 310, a workload network requirement descriptor 320, and one or more workload storage requirement descriptors 330, 340, and 350. In the illustrated embodiment, a multi-tiered application is launched based upon service profile 300, where the collection of workloads 302, 304, and 306 are each launched to perform a particular application.

Workload processing requirement descriptor 310 includes descriptor information describing the processing needs for workload requirement 302. For example, workload processing requirement descriptor 310 can describe a number of processors or threads to allocate to the workload, a memory size needed, specific instructions to a virtual machine manager in the host processing system, descriptions of other workload processing requirements, or a combination thereof. For example, workload processing requirement descriptor 310 can be used by virtual machine allocation framework 158 to launch workload 302 by providing the workload processing requirement descriptor to the virtual machine manager in the selected host processing system.

Workload network requirement descriptor 320 includes descriptor information describing the network switching needs for workload requirement 302. For example, workload network requirement descriptor 320 can describe a network throughput requirement, a connectivity redundancy, a QoS level, another network service requirement, or a combination thereof. For example, workload network requirement descriptor 320 can be used by network allocation framework 159 to allocate the required network switching services.

Workload storage requirement descriptor 330 is illustrative of workload storage requirement descriptors 340 and 350, and includes descriptor information describing the storage needs for workload requirement 302. For example, workload storage requirement descriptor 330 can describe a type of storage needed, such as block storage, file storage, object storage, or another type of storage. Where a combination of storage types are needed, each workload storage requirement descriptor 330, 340, and 350 specifies the storage requirements for a different storage type. In a particular embodiment, one of workload storage requirement descriptors 330, 340, and 350 includes a boot image storage allocation for service profile 300. In another embodiment (not illustrated), a single workload storage requirement descriptor specifies the storage requirements for all of the different storage types needed. Workload storage requirement descriptor 330 can also describe a needed storage capacity or a nominal or peak load, such as in terms of megabytes per second (MB/s), gigabytes per second (GB/s), I/O transactions per second (IO/s), or another load rate. Storage availability can also be specified, such that the data has high availability, medium availability, or low availability, as can be provided by, for example, solid state storage, disk storage, or tape back-up, respectively. Tiered storage levels can also be specified, such as Tier 1 storage for mission critical data or other high utilization data, Tier 2 storage for less critical storage, and Tier 3 storage for back-up or other seldom used data. Workload storage requirement descriptor 330 can also include the data access latency requirements. Where workload 302 is a migrated workload, workload storage requirement descriptor 330 can also include a location for the current workload data, such as a file location, a universal resource locator (URL), a particular SAN device, other location information, or a combination thereof. Workload storage requirement descriptor 330 is used by a storage allocation framework similar to storage allocation frameworks 157 or 230 to allocate the storage resources of a SAN associated with the information handling system.

In a particular embodiment (not illustrated), a separate service profile similar to service profile 300 is provided to the virtualization manager when a workload is being deleted or migrated out of the information handling system. In this case, the service profile can include a workload identifier for the workload to be deleted or migrated, and can direct the virtualization manager to free up the resources that are allocated to the identified workload. In another embodiment, service profile 300 can be formatted in a manner that complies with one or more virtualization standards. For example, service profile 300 can be formatted in compliance with a Distributed Management Task Force (DMTF) Open Virtualization Format (OVF), a Microsoft Exchange service format, an SQL service format, an Oracle database service format, another standard format, or a combination thereof. Service profile 300 can also include specific extensions to the one or more virtualization standards, such as a Web Services-Management (WS-MAN) extension, extensions defined by a particular hardware provider, other extensions, or a combination thereof.

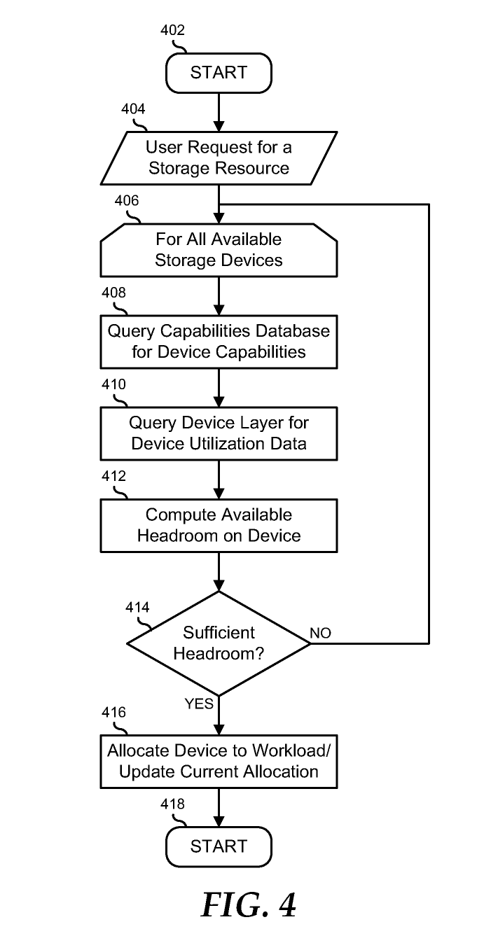

FIG. 4 illustrates an embodiment of a method for storage allocation in a cloud environment. The method starts at block 402 and a user request for a storage resource is received at block 404. For example, service profile 300 can be provided to workload interface 238, and the workload interface can determine a storage resource request from workload storage requirement 330. A loop is entered in which the storage devices of a SAN are singly considered for satisfying the storage resource request in loop block 406. For example, a selected storage device 212, 214, or 214 can be evaluated by a looping process to determine if the storage device is available for satisfying the storage resource request. A capabilities database is queried to determine the device capabilities for the selected device in block 408. For example, capabilities database 234 can determine the capabilities of device adapter 213 and of storage device 214 by polling device layer 232 as to the capabilities, and can provide the information to storage manager 236. In another example, capabilities database 234 can pre-determine the capabilities of SAN 210, such that when a storage resource request is received, the capabilities database provides the information to storage manager 236 without having to poll device adapter 213 and storage device 214.

A device layer is queried to determine the device utilization data for the selected device in block 410. For example, performance extension 233 can determine the utilization of device adapter 213 and can provide the information to storage manager 236. The available headroom of the selected device is computed in block 412. For example, storage manager 236 can use the performance information from block 410, and the capabilities information from block 408 to determine if storage device 212 has sufficient headroom to satisfy the storage resource request. A decision is made as to whether or not there is sufficient headroom on the device in decision block 414. If so, the “YES” branch of decision block 414 is taken and the selected device is allocated to the workload associated with the request, and the current allocation of the SAN is updated in block 416, and the method ends in block 418. If there is not sufficient headroom on the device, the “NO” branch of decision block 414 is taken, and processing returns to loop block 404, where the next device is selected.

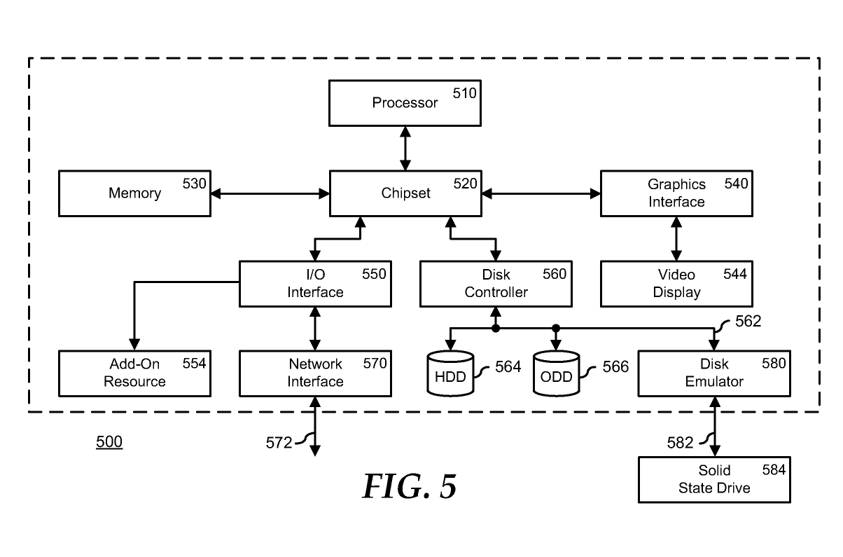

FIG. 5 shows an illustrative embodiment of an information handling system 100 in accordance with at least one embodiment of the present disclosure. Information handling system 300 can include a set of instructions that can be executed to cause the computer system to perform any one or more of the methods or computer based functions disclosed herein. Information handling system 100 may operate as a standalone device or may be connected such as using a network, to other information handling systems or peripheral devices.

In a networked deployment, information handling system 500 can operate in the capacity of a server or as a client user computer in a server-client user network environment, or as a peer computer system in a peer-to-peer (or distributed) network environment. Information handling system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, information handling system 500 can be implemented using electronic devices that provide voice, video or data communication. Further, while a single information handling system 500 is illustrated, the term “system” shall also be taken to include any collection of systems or sub-systems that individually or jointly execute a set, or multiple sets, of instructions to perform one or more computer functions.

Information handling system 500 includes processor 510, a chipset 520, a memory 530, a graphics interface 540, an input/output (I/O) interface 550, a disk controller 560, a network interface 570, and a disk emulator 580. Processor 510 is coupled to chipset 520. Chipset 520 supports processor 510, allowing processor 510 to process machine-executable code. In a particular embodiment (not illustrated), information handling system 500 includes one or more additional processors, and chipset 520 supports the multiple processors, allowing for simultaneous processing by each of the processors, permitting the exchange of information between the processors and the other elements of information handling system 500. Processor 510 can be coupled to chipset 520 via a unique channel, or via a bus that shares information between processor 510, chipset 520, and other elements of information handling system 500.

Memory 530 is coupled to chipset 520. Memory 530 can be coupled to chipset 520 via a unique channel, or via a bus that shares information between chipset 520, memory 530, and other elements of information handling system 500. In particular, a bus can share information between processor 510, chipset 520 and memory 530. In a particular embodiment (not illustrated), processor 510 is coupled to memory 530 through a unique channel. In accordance with another aspect (not illustrated), an information handling system can include a separate memory dedicated to each of the processors. A non-limiting example of memory 530 includes static, dynamic. Or non-volatile random access memory (SRAM, DRAM, or NVRAM), read only memory (ROM), flash memory, another type of memory, or any combination thereof.

Graphics interface 540 is coupled to chipset 520. Graphics interface 540 can be coupled to chipset 520 via a unique channel, or via a bus that shares information between chipset 520, graphics interface 540, and other elements of information handling system 500. Graphics interface 540 is coupled to a video display 544. Other graphics interfaces (not illustrated) can also be used in addition to graphics interface 540 if needed or desired. Video display 544 can include one or more types of video displays, such as a flat panel display or other type of display device.

I/O interface 550 is coupled to chipset 520. I/O interface 550 can be coupled to chipset 520 via a unique channel, or via a bus that shares information between chipset 520, I/O interface 550, and other elements of information handling system 500. Other I/O interfaces (not illustrated) can also be used in addition to I/O interface 550 if needed or desired. I/O interface 550 is coupled to one or more add-on resources 554. Add-on resource 554 can also include another data storage system, a graphics interface, a network interface card (NIC), a sound/video processing card, another suitable add-on resource or any combination thereof.

Network interface device 570 is coupled to I/O interface 550. Network interface 570 can be coupled to I/O interface 550 via a unique channel, or via a bus that shares information between I/O interface 550, network interface 570, and other elements of information handling system 500. Other network interfaces (not illustrated) can also be used in addition to network interface 570 if needed or desired. Network interface 570 can be a network interface card (NIC) disposed within information handling system 500, on a main circuit board (e.g., a baseboard, a motherboard, or any combination thereof), integrated onto another component such as chipset 520, in another suitable location, or any combination thereof. Network interface 570 includes a network channel 572 that provide interfaces between information handling system 500 and other devices (not illustrated) that are external to information handling system 500. Network interface 570 can also include additional network channels (not illustrated).

Disk controller 560 is coupled to chipset 510. Disk controller 560 can be coupled to chipset 520 via a unique channel, or via a bus that shares information between chipset 520, disk controller 560, and other elements of information handling system 500. Other disk controllers (not illustrated) can also be used in addition to disk controller 560 if needed or desired. Disk controller 560 can include a disk interface 562. Disk controller 560 can be coupled to one or more disk drives via disk interface 562. Such disk drives include a hard disk drive (HDD) 564 or an optical disk drive (ODD) 566 (e.g., a Read/Write Compact Disk (R/W-CD), a Read/Write Digital Video Disk (R/W-DVD), a Read/Write mini Digital Video Disk (R/W mini-DVD), or another type of optical disk drive), or any combination thereof. Additionally, disk controller 560 can be coupled to disk emulator 580. Disk emulator 580 can permit a solid-state drive 584 to be coupled to information handling system 500 via an external interface. The external interface can include industry standard busses (e.g., USB or IEEE 1384 (Firewire)) or proprietary busses, or any combination thereof. Alternatively, solid-state drive 584 can be disposed within information handling system 500.

In a particular embodiment, HDD 544, ODD 566, solid state drive 584, or a combination thereof include a computer-readable medium in which one or more sets of machine-executable instructions such as software, can be embedded. For example, the instructions can embody one or more of the methods or logic as described herein. In a particular embodiment, the instructions reside completely, or at least partially, within memory 530, and/or within processor 510 during execution by information handling system 500. Memory 530 and processor 510 can also include computer-readable media.

When referred to as a “device,” a “module,” or the like, the embodiments described above can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A system comprising:
a host processing system operable to launch one or more virtual machines;
a switched fabric coupled to the host processing system and operable to provide network connectivity to the one or more virtual machines;
a storage area network coupled to the switched fabric and operable to provide a set of storage capabilities to the one or more virtual machines; and
a virtualized cloud environment manager operable to receive a service profile associated with a workload, the virtualized cloud environment manager including:
a virtual machine allocation framework operable to direct the host processing system to launch one of the virtual machines for providing the workload in response to a workload processing requirement of the service profile;
a network allocation framework operable to direct the switched fabric to provide network connectivity to the one virtual machine in response to a workload network requirement of the service profile; and
a storage allocation framework including:
a workload interface operable to receive a workload storage requirement of the service profile;
a storage capabilities database operable to determine the set of storage capabilities of the storage area network; and
a storage manager operable to determine a storage allocation from the set of storage capabilities and to allocate the storage allocation to the workload based on the workload storage requirement.

2. The system of claim 1, the virtualized cloud environment manager further including a device layer coupled to a storage device of the storage area network, the device layer operable to provide the set of storage capabilities to the storage capabilities database based upon a device capability of the storage device.

3. The system of claim 2, wherein the device capability includes a static capability of the storage device.

4. The system of claim 2, wherein the device layer includes a performance extension operable to determine performance information of the storage area network.

5. The system of claim 4, wherein the performance information includes a current utilization of the storage area network.

6. The system of claim 1, wherein the storage manager is further operable to monitor an actual usage of the storage allocation by the workload.

7. The system of claim 6, wherein the storage manager is further operable to provide a charge back based upon the actual usage.

8. The system of claim 1, wherein:
the workload storage requirement includes:
a boot image for the workload; and
a data instance for the workload; and
the storage manager is further operable to include the boot image and the data instance in the storage allocation.

9. The system of claim 8, wherein the storage manager is further operable to import the boot image and the data instance to the storage area network.

10. A virtualized cloud environment manager operable to receive a service profile associated with a workload, the virtualized cloud environment manager comprising:
a virtual machine allocation framework operable to direct a host processing system to launch a virtual machine for providing the workload in response to a workload processing requirement of the service profile; and
a storage allocation framework including:
a workload interface operable to receive a first workload storage requirement of the service profile;
a storage capabilities database operable to determine a first storage capability of a storage area network;
a storage manager operable to determine a first storage allocation from the first storage capability, and to allocate the first storage allocation to the workload based on the first workload storage requirement; and
a device layer coupled to a first storage device of the storage area network, the device layer operable to provide the first storage capability to the storage capabilities database based upon a first device capability of the first storage device.

11. The virtualized cloud environment manager of claim 10, wherein:
the workload interface is further operable to receive a second workload storage requirement of the service profile;
the storage capabilities database is further operable to determine a second storage capability of the storage area network;
the storage manager is further operable to determine a second storage allocation from the second storage capability and to allocate the second storage allocation to the workload based on the second workload storage requirement; and
the device layer is coupled to a second storage device of the storage area network, the device layer further operable to provide the second storage capability to the storage capabilities database based upon a second device capability of the second storage device.

12. The virtualized cloud environment manager of claim 10, wherein the device layer includes a performance extension operable to determine performance information of the storage area network.

13. The virtualized cloud environment manager of claim 12, wherein the performance information includes a current utilization of the storage area network.

14. The virtualized cloud environment manager of claim 10, wherein the storage manager is further operable to:
monitor an actual usage of the first storage allocation by the workload; and
provide a charge back based upon the actual usage.

15. The virtualized cloud environment manager of claim 10, wherein:
The first workload storage requirement includes:
a boot image for the workload; and
a data instance for the workload; and
the storage manager is further operable to include the boot image and the data instance in the storage allocation.

16. A method comprising:
receiving a service profile associated with a workload at a virtualized cloud environment manager;
directing a host processing system to launch a virtual machine for providing the workload in response to a workload processing requirement of the service profile;
directing a switched fabric to provide network connectivity to the workload in response to a workload network requirement of the service profile;
determining a storage capability of a storage area network;
storing the storage capability in a storage capabilities database;
determining a storage allocation based upon a workload storage requirement of the storage profile and upon the storage capability; and
directing the storage area network to provide a storage allocation to the workload in response to a workload storage requirement of the service profile.

17. The method of claim 16, wherein the storage capability is determined based upon a device capability of a storage device.

18. The method of claim 16, further comprising monitoring an actual usage of the storage allocation by the workload.

19. The method of claim 18, further comprising providing a charge back based upon the actual usage.

20. The method of claim 16, wherein:
the workload storage requirement includes:
a boot image for the workload; and
a data instance for the workload;
the method further comprising providing the boot image and the data instance in the storage allocation.
